(19) United States
(12) Patent Application Publication
(10) Pub. No.: US 2017/0161003 A1
(43) Pub. Date: Jun. 8, 2017

(54) Website and mobile application showing lift status of drawbridges

(71) Applicant: Sam Burris, Sturgeon Bay, WI (US)

(72) Inventor: Sam Burris, Sturgeon Bay, WI (US)

(21) Appl. No.: 14/961,391

(22) Filed: Dec. 7, 2015

(51) Int. Cl. G06F 3/14; H04W 4/12; G06F 3/0481; H04L 29/08; G05B 19/05; G09G 5/12

(52) U.S. Cl. CPC G06F 3/14; G05B 19/054; G09G 5/12; G06F 3/0481; H04L 67/025; H04W 4/12; G05B 2219/14098; G05B 2219/13144; G09G 2370/02

(57) ABSTRACT

A website system and mobile application showing the lift status of drawbridges uses sensors, a bridge operator, a website and a mobile application. The sensors detect whether the bridge is raised or lowered and then communicates the information to the managing entity of the website and the mobile application. The bridge operator provides additional information regarding the condition of the bridge, which is updated on the website. The website provides the public with up-to-date information, alerting users regarding the current raised or lowered status of the bridge, and may be accessed using the mobile application.

### CROSS-REFERENCE TO RELATED APPLICATIONS

This application claims the benefit of U.S. Provisional Application No. 62/088,616, filed Dec. 7, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to navigational websites and in particular to a website system and mobile application showing the lift status of drawbridges. Many regions of the country rely on drawbridges to accommodate both highway and maritime traffic at critical points. Unfortunately, when a drawbridge is raised, highway traffic can be interrupted for up to 30 minutes. There are many drivers who would prefer to spend that time doing something else, such as having breakfast, rather than just sitting in their cars. Other drivers may have more time-sensitive purposes, such as an ambulance driver trying to reach an emergency ward with an injured accident victim, and would like to know before reaching whether the drawbridge will be raised, so that they can find an alternate route. A website system and mobile application showing the lift status of drawbridges, which monitors drawbridges nationwide and provides alerts to users, will resolve this problem.

### SUMMARY OF THE INVENTION

Accordingly, the invention is directed to a website system and mobile application showing the lift status of drawbridges. The system uses sensors, a bridge operator, a website and a mobile application. The sensors detect whether the bridge is raised or lowered and then communicates the information to the managing entity of the website and the mobile application. The bridge operator provides additional information regarding the condition of the bridge, which is updated on the website. The website provides the public with up-to-date information, alerting users regarding the current raised or lowered status of the bridge, and may be accessed using the mobile application.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a front perspective view of the website and mobile application of the first exemplary embodiment displayed on an electronic device, displaying the map display 10, the electronic device 11, and the visual display 12.

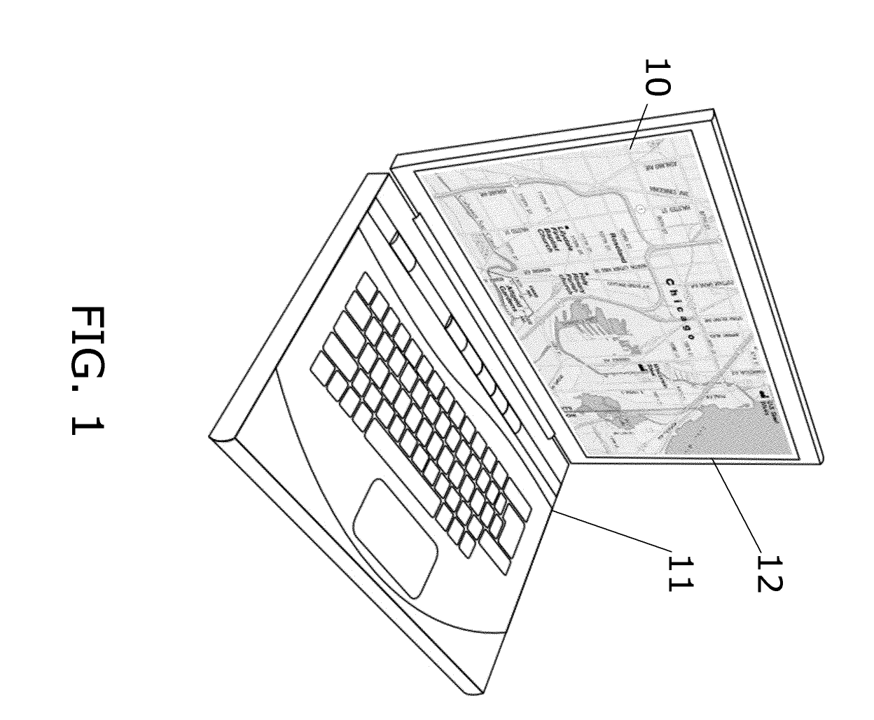

FIG. 2 shows a system schematic of the bridge status system.

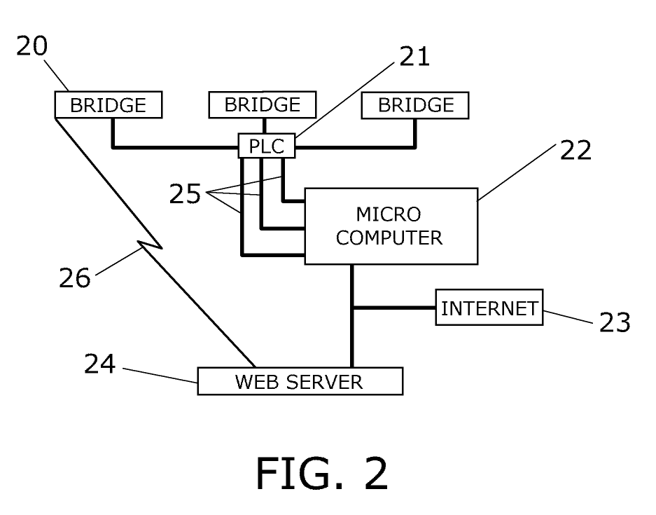

### DETAILED DESCRIPTION OF THE INVENTION

Referring now to the invention in more detail, the invention is directed to a website system and mobile application showing the lift status of drawbridges.

The first exemplary embodiment is directed to a website system which uses a means of detecting whether a bridge is raised or lowered 20, a bridge operator, and a website 24. The sensors 20 detect whether the bridge is raised or lowered and then communicates the information to the managing entity of the website. The bridge operator provides additional information regarding the condition of the bridge, which is updated on the website 24. The bridge operator may notify the managing entity of such conditions as an approaching ship, requiring the bridge to be raised in fifteen minutes.

The website provides the public with up-to-date information, alerting users regarding the current raised or lowered status of the bridge. The location of the bridge, color-coded for the raised or lowered status of the bridge, is provided on a map display 10, which is available for viewing via the visual display 12 of any electronic device 11 with Internet access. The mobile application is available for downloading and installation on the user's electronic device 11.

The system consists of a means of detecting the bridge's status 20 located at the bridges themselves. This can be optical sensors, motion sensors, circuit sensors, or any other reliable means of determining whether the bridge is open or closed. The means of detecting the bridge's status 20 is connected to a programmable logic controller 21. The programmable logic controller 21 is connected to a microcomputer 22 via simple two-wire, relay connects 25, which will open or close along with the bridges status. The microcomputer 22 will access the webserver 24 with a URL (uniform resource location) which contains update fields for bridge status. The webserver 24 is connected to the internet 23, allowing users to access the website and data therein.

The webserver 24 has a database which tracks the bridge status. Each bridge has a bridge id code. Each bridge id code has a bridge status associated with it. The bridge status can be inactive, bridge down, bridge up, road closed indefinitely, bridge closed temporarily, or any other appropriate indicator of the bridge status. A notes section is available for a bridge operator to enter specific notes on the bridge status. The webserver 24 updates the status of each bridge whenever the microcomputer 22 receives a change in status from one of the programmable logic controllers 21.

In an alternate embodiment, the means of detecting the bridge status is a device which includes a cell phone and a battery. When the bridge status changes, the cell phone would text the webserver directly 26, updating the status of the bridge. The webserver would then update the bridge status so that the website accessed by the users would have the current bridge status.

To use the first exemplary embodiment, the user may open the website with the mobile application and employ the map display 10 to determine whether a bridge on the user's route is raised, and whether an alternate route is available. Navigational software may be provided as part of the mobile application, which will request the user's destination and current location or acquire it via the Global Positioning System (GPS), then calculate and display the fastest route around the raised bridge.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A drawbridge status system comprising:
a. a means of detecting whether a bridge is raised or lowered such that the means of detecting whether a bridge is raised or lowered determines a bridge status;
b. said means of detecting whether a bridge is raised or lowered being installed on a bridge;
c. a programmable logic controller;
d. said means of detecting whether a bridge is raised or lowered being electronically connected to said programmable logic controller;
e. a microcomputer;
f. said programmable logic controller being connected to said microcomputer via two-wire relay connects such that the bridge status is communicated to said microcomputer;
g. a webserver having a database;
h. said microcomputer being connected to said webserver such that the bridge status is communicated to said webserver;
i. said database having data being updated when the bridge status is communicated from said microcomputer;
j. wherein said webserver is connected to the internet and a website such that it is accessible via electronic devices with internet connection.

2. The drawbridge status system of claim 1, wherein said means of detecting whether a bridge is raised or lowered is one or more of an optical sensor, motion sensor, circuit sensor, or any other reliable means of determining whether a bridge is raised or lowered.

3. The drawbridge status system of claim 1, wherein said database further comprises a plurality of bridge id codes; said bridge id codes being associated with a particular bridge; a bridge status code; said bridge status code being displayed as a particular bridge status and associated with a particular bridge.

4. The drawbridge status system of claim 3, further comprising a note code; said note code being set by a bridge operator manually entering notes about the bridge status.

5. The drawbridge status system of claim 1, further comprising a map display; said map display showing the location of particular bridges and the bridge status of the particular bridges.

6. A drawbridge status system comprising:
a. a means of detecting whether a bridge is raised or lowered such that the means of detecting whether a bridge is raised or lowered determines a bridge status;
b. said means of detecting whether a bridge is raised or lowered being installed on a bridge;
c. a webserver having a database;
d. said means of detecting whether a bridge is raised or lowered being configured to communicated directly with said webserver;
e. said database having data being updated when the bridge status is communicated from said microcomputer;
f. wherein said webserver is connected to the internet and a website such that it is accessible via electronic devices with internet connection.

7. The drawbridge status system of claim 6, wherein said means of detecting whether a bridge is raised or lowered comprises a cell phone; said cell phone communicating directly with said webserver via text messaging.

8. The drawbridge status system of claim 6, wherein said database further comprises a plurality of bridge id codes; said bridge id codes being associated with a particular bridge; a bridge status code; said bridge status code being displayed as a particular bridge status and associated with a particular bridge.

9. The drawbridge status system of claim 7, wherein said database further comprises a plurality of bridge id codes; said bridge id codes being associated with a particular bridge; a bridge status code; said bridge status code being displayed as a particular bridge status and associated with a particular bridge.

10. The drawbridge status system of claim 8, further comprising a note code; said note code being set by a bridge operator manually entering notes about the bridge status.

11. The drawbridge status system of claim 9, further comprising a note code; said note code being set by a bridge operator manually entering notes about the bridge status.

12. The drawbridge status system of claim 6, further comprising a map display; said map display showing the location of particular bridges and the bridge status of the particular bridges.

13. The drawbridge status system of claim 7, further comprising a map display; said map display showing the location of particular bridges and the bridge status of the particular bridges.
